(19) United States
(12) Patent Application Publication
(10) Pub. No.: US 2026/0188924 A1
(43) Pub. Date: Jul. 2, 2026

(54) POWER SUPPLY DEVICE AND HOME APPLIANCE INCLUDING POWER SUPPLY DEVICE

(71) Applicant: SAMSUNG ELECTRONICS CO., LTD., Suwon-si (KR)

(72) Inventors: Eunha LIM, Suwon-si (KR); Byeongwoo KIM, Suwon-si (KR); Kanghyun LEE, Suwon-si (KR); Bokyun KIM, Suwon-si (KR)

(73) Assignee: SAMSUNG ELECTRONICS CO., LTD., Suwon-si (KR)

(21) Appl. No.: 19/463,759

(22) Filed: Jan. 29, 2026

Related U.S. Application Data
(63) Continuation of application No. PCT/KR2025/022175, filed on Dec. 18, 2025.

(30) Foreign Application Priority Data
Dec. 31, 2024 (KR) 10-2024-0202940
Feb. 25, 2025 (KR) 10-2025-0024190

(51) Int. Cl. H01R 9/24; D06F 34/10

(52) U.S. Cl. CPC H01R 9/2416; D06F 34/10

(57) ABSTRACT

A washing machine includes a housing and a power supply device disposed on one side of the housing. The power supply device includes a terminal block disposed on one side of the housing for screw coupling between internal and external wires connected to components within the housing, a block guide disposed in a form surrounding the terminal block, and a cover covering the terminal block and the block guide.

### CROSS-REFERENCE TO RELATED APPLICATIONS

This application is a continuation application, claiming priority under 35 U.S.C. § 365(c), of an International application No. PCT/KR 2025/022175, filed on Dec. 18, 2025, which is based on and claims the benefit of a Korean patent application number 10-2024-0202940, filed on Dec. 31, 2024, in the Korean Intellectual Property Office, and a Korean patent application number 10-2025-0024190, filed on Feb. 25, 2025, in the Korean Intellectual Property Office, the disclosure of which is incorporated by reference herein in its entirety.

### TECHNICAL FIELD

Apparatuses and methods consistent with the disclosure relate to a power supply device and a home appliance including the same.

### BACKGROUND ART

With the advancement of electronic technology, various types of electronic devices, such as washing machines, air conditioners, refrigerators, and vacuum cleaners, are being used in homes. These products are commonly referred to as home appliances.

The home appliance is a device in which multiple components and systems operate organically to perform various functions. The home appliance utilizes various components electrically connected to sequentially perform processes appropriate for each function. To this end, the home appliance may include a power supply device for electrical connection between the components.

### DISCLOSURE OF INVENTION

### Solution to Problem

Meanwhile, there has been a problem in that the screw connecting the terminal block of the power supply device to the home appliance became detached and was lost while the home appliance is operating.

Embodiments of the present disclosure may address at least one of the aforementioned problems and/or disadvantages and provide the advantages described below. Accordingly, various embodiments of the present disclosure provide a power supply device and a home appliance including the same.

Additional embodiments will be presented in the detailed description to be described below, some of which will be apparent from the detailed description, and other embodiments may also be presented through learning from the presented embodiments.

In accordance with an aspect of the disclosure, a washing machine may include a main body, and a power supply device on a side of the main body. In accordance with an aspect of the disclosure, the power supply device may include a terminal block, a block guide, and a cover. The terminal block may be configured to electrically connect an external wire and an internal wire that are couplable together by a first fastener, wherein the internal wire is electrically connected to a component within the main body such that, when the external wire and the internal wire are electrically connected by the terminal block and coupled together by the first fastener, power from an external power supply is suppliable through the external wire and the internal wire to the component. The block guide may surround the terminal block and may be configured to, in an event that the first fastener falls, catch and store the first fastener. The cover may cover the terminal block and the block guide.

In accordance with another aspect of the disclosure, a power supply device may include a terminal block, a block guide, and a cover. The terminal block may be couplable to a main body of a home appliance and configured to, while coupled to the main body, electrically connect an external wire and an internal wire that are couplable together by a first fastener, wherein the internal wire is electrically connectable to a component within the main body such that, when the external wire and the internal wire are electrically connected by the terminal block and coupled together by the first fastener with the internal wire connected to the component, power from an external power supply is suppliable through the external wire and the internal wire to the component. The block guide may be configured to surround the terminal block coupled to the main body and, while surrounding the terminal block, to, in an event that the first fastener falls, catch and store the first fastener. The cover may be configured to cover the terminal block coupled to the main body and the block guide surrounding the terminal block.

In accordance with another aspect of the disclosure, a washing machine may include a main body and a power supply device on a side of the main body. The power supply device may include a terminal block, a block guide, and a cover. The terminal block may be coupled to the main body by a fastener, and may be configured to electrically connect an external wire and an internal wire, wherein the internal wire is electrically connected to a component within the main body such that, when the external wire and the internal wire are electrically connected by the terminal block, power from an external power supply is suppliable through the external wire and the internal wire to the component. The block guide may surround the terminal block and may be configured to, in an event that the fastener falls, catch and store the fastener. The cover may cover the terminal block and the block guide.

### BRIEF DESCRIPTION OF DRAWINGS

The above-described contents and other aspects, features, and benefits of embodiments of the present disclosure will become more apparent from the following description taken in conjunction with the accompanying drawings. In the accompanying drawings:

FIG. 1 is a diagram illustrating various home appliances according to at least one embodiment of the present disclosure;

FIG. 2 is a diagram for describing a washing machine according to at least one embodiment of the present disclosure;

FIG. 3 is a diagram for describing a washing machine including a power supply device according to at least one embodiment of the present disclosure;

FIG. 4 is an enlarged view illustrating portion ‘A’ of FIG. 3;

FIG. 5 is a diagram for describing a terminal block according to at least one embodiment of the present disclosure;

FIG. 6 is a diagram for describing a block guide according to at least one embodiment of the present disclosure;

FIG. 7 is a diagram for describing a terminal block and block guide according to at least one embodiment of the present disclosure;

FIG. 8 is a diagram for describing a power supply device according to at least one embodiment of the present disclosure;

FIG. 9 is a diagram for describing a block guide according to at least one embodiment of the present disclosure; and

FIG. 10 is a diagram for describing a cover according to at least one embodiment of the present disclosure.

FIG. 11 is a diagram for describing a cover according to at least one embodiment of the present disclosure.

### MODE FOR INVENTION

Various embodiments of the present disclosure and terms used therein are not intended to limit the technical features described in the present disclosure to specific embodiments, and should be understood to include various changes, equivalents, or substitutes of the embodiments.

Throughout the accompanying drawings, similar or related components will be denoted by similar reference numerals.

A singular form of a noun corresponding to an item may include one or more of the item, unless the relevant context clearly dictates otherwise.

In the present document, each phrase such as “A or B,” “at least one of A and B,” “at least one of A, and B”, “at least one of A or B,” “at least one of A, or B”, “A, B, or C,” “at least one of A, B and C,”, “at least one of A, B, and C”, “at least one of A, B, or C”, and similar phrases, may include any one of items listed together in the corresponding one of those phrases, or all possible combinations thereof.

A term ‘and/or’ includes a combination of a plurality of related described components or any one of the plurality of related described components.

Terms such as “first,” “second,” “1st,” or “2nd” may simply be used to distinguish a component from another component, and do not limit the components in other respects (e.g., importance or order).

When one (e.g., first) component is “coupled,” or “connected,” to another (e.g., second) component with or without the terms “functionally” or “communicatively,” it means that the one component may be connected to another component directly (e.g., in a wired manner), in a wireless manner, or through a third component.

It will be understood that terms ‘include’ or ‘have’ specify the presence of features, numerals, steps, operations, components, parts mentioned in the present document, or a combination thereof, but do not preclude the presence or addition of one or more other features, numerals, steps, operations, components, parts, or a combination thereof.

When a component is said to be “connected,” “coupled,” “supported,” or “in contact” with another component, this includes not only cases where the components are directly connected, coupled, supported, or in contact, but also cases where they are indirectly connected, coupled, supported, or in contact through a third component.

When a component is “on” another component, this includes not only cases where a component is in contact with another component, but also cases where there is another component between the two components.

In an embodiment, a plurality of ‘modules’ or a plurality of ‘portions’ may be integrated in at least one module and be implemented by at least one processor except for a ‘module’ or a ‘portion’ that needs to be implemented by specific hardware.

Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

Meanwhile, various elements and regions in the drawings are schematically illustrated. Therefore, the spirit of the disclosure is not limited by relatively sizes or intervals illustrated in the accompanying drawings.

Hereinafter, a home appliance1 according to various embodiments will be described in detail with reference to the drawings.

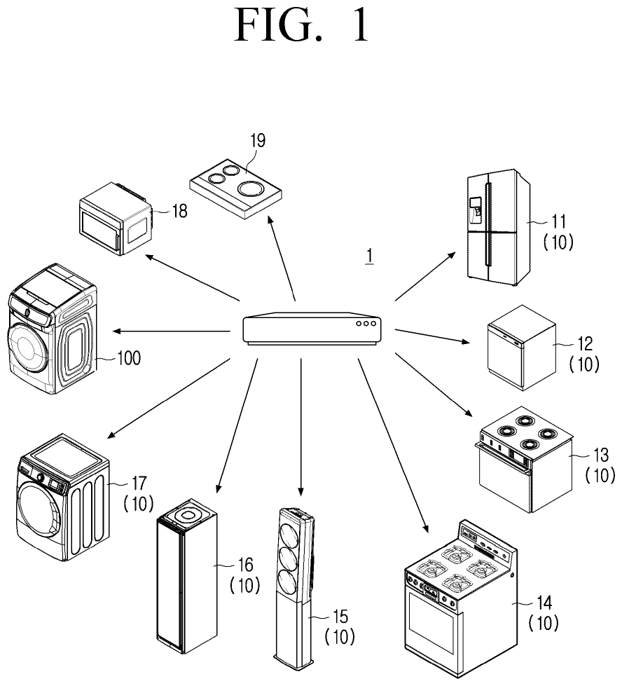

FIG. 1 illustrates the home appliance1 according to at least one embodiment of the present disclosure.

The home appliance1 refers to an electronic device designed for use in daily life within a household. The home appliance1 may include various types of home appliances. For example, as illustrated, the home appliance1 may include at least one of a refrigerator 11, a dishwasher 12, a gas range 13, an electric oven 14, an air conditioner 15, a clothing care machine 16, a dryer 17, a washing machine 100, a microwave oven 18, and a cooking device 19. However, in implementation, the home appliance 1 may also include other types of home appliances, such as a cleaning robot, a vacuum cleaner, and a television, in addition to the devices mentioned above.

In addition, the home appliances1 described above are merely examples, and in addition to the home appliances described above, various devices that may be connected to other home appliances, user devices, or servers to perform operations may be included in the home appliance 1 according to an embodiment.

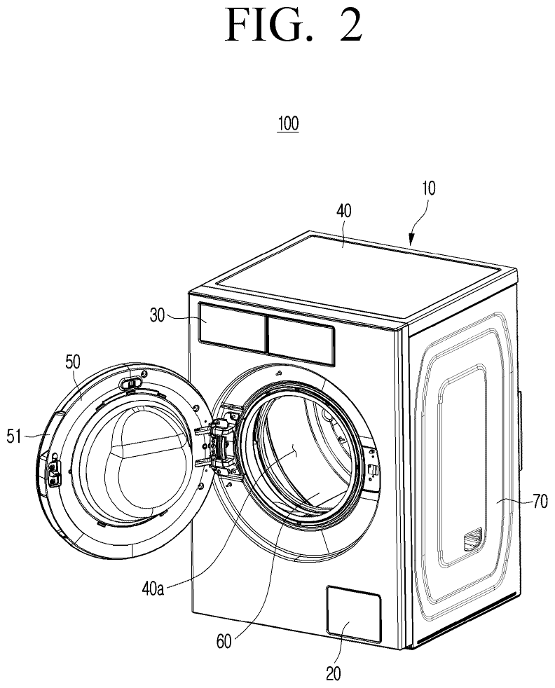

Meanwhile, for a detailed description of a power supply device of the present disclosure, the description will be based on a washing machine 100 with reference to FIG. 2.

In FIG. 2, the washing machine 100 is a device capable of performing washing, rinsing, dehydrating, and drying cycles.

In FIG. 2, the washing machine 100 is illustrated as a front-loading type with a laundry loading port provided to face forward. However, the washing machine according to various embodiments of the present disclosure is not necessarily limited to this type. For example, the washing machine 100 may be implemented in a top-loading type in which a laundry inlet for inputting or withdrawing laundry is provided to face upward, and may also include a washing machine of various loading types.

In the case of the top-loading washing machine, laundry may be washed using water currents generated by a rotating body such as a pulsator. For the front-loading washing machine, laundry may be washed by repeatedly lifting and dropping the laundry by rotating the drum.

The front-loading washing machine may include a washer-dryer combo capable of drying laundry stored within the drum. The washer-dryer combo may include a hot air supply device to supply high-temperature air into the drum and a condensing device for removing moisture from the air discharged from the drum. When implemented as the washer-dryer combo, the washing machine 100 may sequentially perform washing and drying.

In FIG. 2, the washing machine 100 may include a main body 10, a detergent input module 30, a door 50, a drum 60, and a drying device. Here, the washing machine may be the washer-dryer combo or a clothing treatment device.

The main body 10 forms an appearance of the washing machine. The main body 10 may be formed to have a hollow hexahedral shape so that various components may be stored therein. The main body 10 may also be referred to as a housing, a cabinet, etc.

The main body 10 may include an upper surface portion 40, a side surface portion 70, etc. The upper surface portion 40 and the side surface portion 70 may be formed in a flat shape.

An opening 40a may be formed on a front surface of the main body 10, and the opening 40a may be opened or closed by the door 50.

The door 50 may be shaped to correspond to the opening 40a of the main body 10 and may be rotatably mounted to the main body 10 by a hinge. At least a portion of the door 50 may be provided to be transparent or translucent so that the inside of the main body 10 may be visible.

A door handle 51 may be provided on one side of the door 50, thereby allowing a user to open or close the opening 40a by easily rotating the door 50 using the door handle 51.

The washing machine 100 may include a tub provided inside the main body 10 to hold water. The tub may have a substantially cylindrical shape with a tub opening on one side, and disposed inside the main body 10 so that the tub opening is disposed to correspond to the laundry loading port.

The tub may be connected to the main body 10 by a damper. The damper may absorb vibrations generated during the rotation of the drum 60 to damp the vibrations transmitted to the main body 10.

A drum 60 may be included inside the tub. The drum 60 is configured to store laundry. The drum 60 may be formed in a hollow cylindrical shape.

The drum 60 may be disposed inside the tub so that the drum opening provided on one side corresponds to the laundry inlet and the tub opening. Laundry may be stored into or withdrawn from the drum 60 by passing through the laundry loading port, the tub opening, and the drum opening in sequence.

The drum 60 may perform each operation according to washing, rinsing, and/or dehydration cycles while rotating within a tub. A cylindrical wall of the drum 60 is formed with a plurality of vent holes, allowing water stored in the tub to be introduced into or discharged from the drum 60.

The washing machine 100 may include a driving device configured to rotate the drum. The driving device may include a driving motor and a rotating shaft for transmitting driving force generated by the driving motor to the drum. The rotating shaft may penetrate through the tub and be connected to the drum. The driving device may rotate the drum forward or backward to perform each operation according to the washing, rinsing, and/or dehydration, or drying cycles.

Although not illustrated in the drawing, the drum 60 may include a drying device for drying laundry contained within the drum. The drying device may be disposed above the tub. The drying device may be configured to heat air and supply the air to the inside of the tub. The drying device may discharge air discharged from the tub to the outside of the washing machine. The washing machine may be configured to suck in outside air, heat the outside air, supply the outside air to the tub to dry clothes inside the drum, dry the clothes inside the drum, and discharge the air discharged from the tub to the outside of the washing machine. Without limitation thereto, the drying device may heat air by a heat pump method and supply the air to the tub.

The washing machine 100 may include a water supply device configured to supply water to the tub. The water supply device may include a water supply pipe and a water supply valve provided on the water supply pipe. The water supply pipe may be connected to an external water source. The water supply pipe may extend from the external water source to a detergent supply device and/or a tub. Water may be supplied to the tub via the detergent supply device. Water may be supplied to the tub without passing through the detergent supply device.

The water supply valve may open or close the water supply pipe in response to an electrical signal from a control unit. The water supply valve may allow or block the supply of water from the external water source to the tub. The water supply valve may include, for example, a solenoid valve that opens and closes in response to an electrical signal.

The washing machine 100 may include an input module 30 for supplying detergent or laundry aid into the tub. The input module 30 may be described in various ways, such as a detergent supply device or a detergent storage device.

The input module 30 may be implemented as a manual detergent supply device that requires a user to manually inject detergent for each wash cycle, an automatic detergent supply device that stores a large quantity of detergent and automatically injects a certain amount of detergent during washing, etc.

The washing machine 100 may include a drainage device 20 configured to discharge water contained in the tub to the outside. The drainage device may include a drain pipe extending from the bottom of the tub to the outside of the main body 10, a drain valve provided in the drain pipe to open and close the drain pipe, and a pump provided on the drain pipe. The pump may pump water in the drain pipe to the outside of the main body 10.

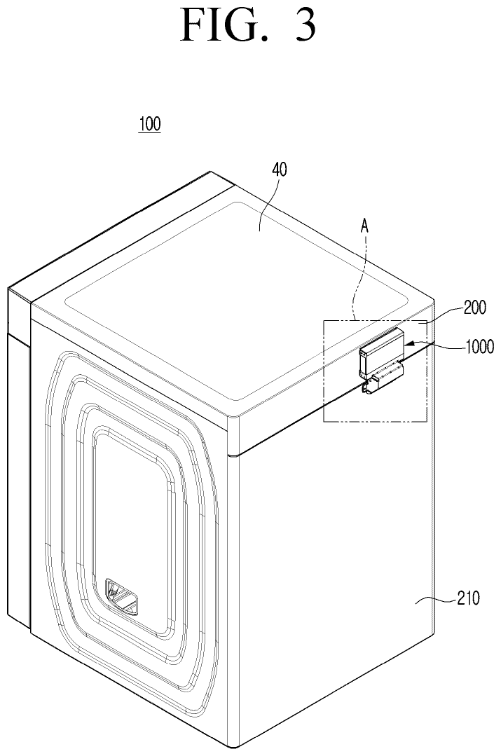

FIG. 3 is a diagram illustrating a rear surface of the washing machine 100 according to at least one embodiment.

In FIG. 3, the washing machine 100 may include a rear frame 200 and a power supply device 1000.

The rear frame 200 is formed on a rear surface portion of the washing machine 100 and may include a coupling part that may be connected to various external devices, such as wires and terminal blocks.

The rear frame 200 may be disposed flat on one side of the washing machine 100.

The power supply device 1000 is a device for supplying power to a home appliance 1. That is, in FIG. 3, the power supply device 1000 is a device for supplying power to the washing machine 100.

The power supply device 1000 may be disposed on one side of the main body 10. The power supply device 1000 may be disposed on one side of the rear frame 200.

The power supply device 1000 may include a terminal block, a block guide, and a cover. A detailed description of these components will be provided later, and thus, a description thereof will be omitted.

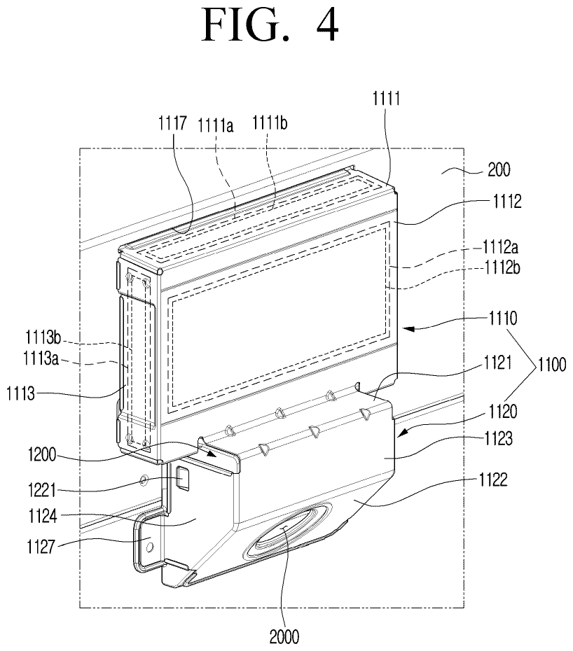

FIG. 4 is an enlarged view illustrating portion ‘A’ of FIG. 3.

In FIG. 4, the power supply device 1000 may be coupled to one side of the main body 10.

The power supply device 1000 may include a terminal block, a cover 1100, and a block guide 1200.

Although not illustrated in FIG. 4, the terminal block may be coupled to the rear frame 200 of the washing machine 100 within the block guide 1200 and the cover 1100. The power supply device may be provided in the drying device, and the cover 1100 may be detachably mounted on the drying device.

The terminal block is configured to electrically connect internal wires connected to components within the main body 10 and external wires for supplying power from an external power supply.

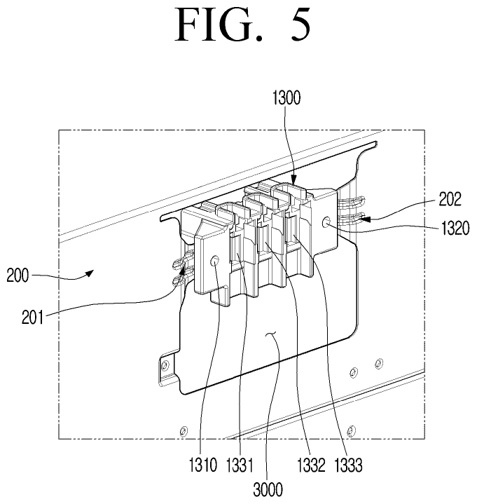

The terminal block may be disposed on one side of the main body 10 for screw coupling between the internal connected to the components within the main body 10 and the external wires for supplying power from an external power supply. A detailed description of the configuration of the terminal block will be provided in FIG. 5, and thus, a detailed description thereof will be omitted.

The block guide 1200 is configured to prevent screw loss during the screw coupling between the internal wires connected to the components within the main body 10 and external wires for supplying power from an external power supply in the terminal block.

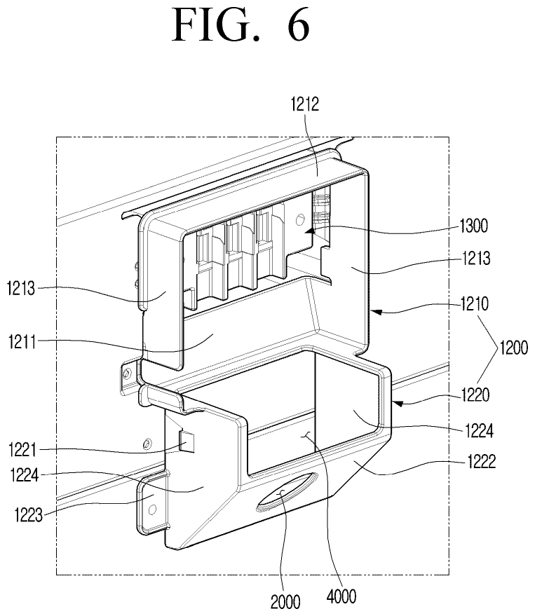

In FIG. 4, the block guide 1200 is covered by the cover 1100. Therefore, a detailed description of the block guide 1200 will be provided in FIG. 6.

In FIG. 4, the cover 1100 is configured to cover both the terminal block and the block guide 1200.

The cover 1100 may be disposed to surround an outer surface of the block guide 1200. The cover 1100 may include a first cover part 1110 for covering the terminal block and a second cover part 1120 for covering the storage part of the block guide 1200.

The first cover part 1110 may include a rectangular parallelepiped shape with one open side, including an upper surface portion 1111, a front surface portion 1112, and a side surface portion 1113 for protecting the terminal block.

The upper surface portion 1111, the front surface portion 1112, and the side surface portion 1113 of the first cover part 1110 may cover an outer side of the block guide 1200 in the form in which the upper surface portion 1111, the front surface portion 1112, and the side surface portion 1113 of the first cover part 1110 surround the outer side of the block guide 1200.

The upper surface portion 1111 of the first cover part 1110 may include a first coupling part 1117 for coupling with the rear frame 200. The first coupling part 1117 may be formed to be fastened to a groove formed in the rear frame 200.

The second cover part 1120 may be disposed below the first cover part 1110. The second cover part 1120 may be formed to cover the storage part of the block guide 1200.

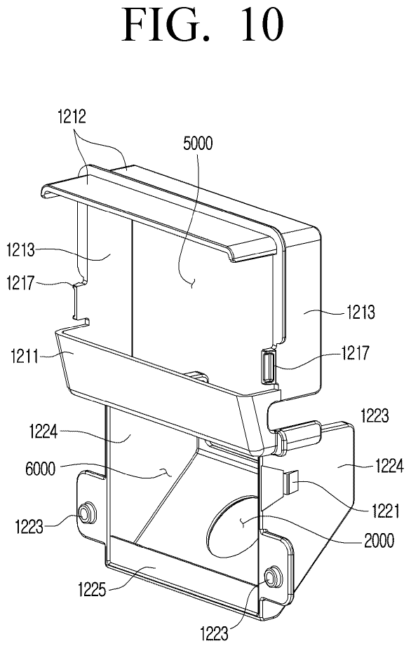

The second cover part 1120 may include a second coupling part 1127 and a third coupling part (reference numeral 1125 of FIG. 10).

The second coupling part 1127 may be disposed on both sides of the second cover part 1120. The second coupling part 1127 may be coupled to the block guide 1200 and the rear frame 200 using the screw. That is, the screw may be rotatably fastened to the groove formed in the rear frame 200, the block guide 1200, and the second cover part 1120 after the block guide 1200 is disposed between the rear frame 200 and the second cover part 1120.

The third coupling part (reference numeral 1125 of FIG. 10) may be disposed on both sides of the second cover part 1120. The third coupling part (reference numeral 1125 of FIG. 10) may be coupled to a protrusion 1221 formed on the block guide 1200. The second cover part 1120 may be fixed by the third coupling part (reference numeral 1125 of FIG. 10) and the protrusion 1221 formed on the block guide 1200.

The second cover part 1120 may include an upper surface portion 1121, a side surface portion 1124, a first front surface portion 1122, and a second front surface portion 1123 to cover the storage part of the block guide 1200.

The upper surface portion 1121, the side surface portion 1124, and the second front surface portion 1123 may be formed in a flat shape.

The upper surface portion 1121 may be disposed below the first cover part 1110. The upper surface portion 1121 may be formed in a partially bent shape. A slot may be formed between the upper surface portion 1121 and the side surface portion 1124. Some members of the block guide 1200 may be opened to the outside through the slot located between the upper surface portion 1121 and the side surface portion 1124.

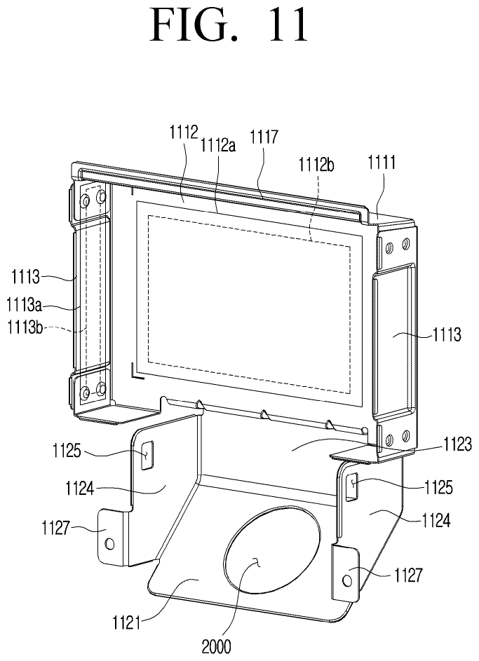

The side surface portion 1124 may include a second coupling part 1127 extended to one side and a third coupling part (reference numeral 1125 of FIG. 10) disposed on the side surface portion 1124. The second coupling part 1127 and the third coupling part (reference numeral 1125 in FIG. 11) have been described above in detail, and therefore, a description thereof will be omitted.

The first front surface portion 1122 may be formed to have a form in which the first front surface portion 1122 is inclined at a certain angle as it moves away from the second front surface portion 1123. The first front surface portion 1122 may be formed to be inclined toward the rear frame 200 as it extends downward. The first front surface portion 1122 may be inclined in a direction approaching the home appliance 1 as it extends downward.

The first front surface portion 1122 may include a hole 2000 on one side thereof. In FIG. 4, the hole 2000 may include a first hole positioned in the storage part of the block guide 1200 and a second hole positioned corresponding to the first hole in the cover 1100. However, for convenience of description, the first hole and the second hole will be collectively referred to as the “hole 2000”.

The hole 2000 is configured to pass the external wire therethrough. The external wire passing through the hole 2000 is connected to the terminal block of the power supply device 1000, thereby supplying power to the home appliance 1 and the washing machine 100.

The front surface portion 1112 of the first cover part 1110 may include the absorbent member 1111a, 1112a, and 1113a disposed on the inner side surface thereof to face the terminal block 1300 to absorb moisture penetrating from the outside.

The front surface portion 1112 of the first cover part 1110 may include the elastic body 1111b, 1112b, and 1113b disposed on the inner side surface thereof to face the terminal block 1300 to absorb the external impact. Accordingly, the durability of the washing machine 100 may be increased.

Here, the elastic body 1111b, 1112b, and 1113b may include various materials, such as rubber and silicone.

FIG. 5 is a diagram for describing a terminal block 1300 according to at least one embodiment of the present disclosure.

The terminal block 1300 is a component that may be electrically connected to the home appliance 1 via wires or cables.

In FIG. 5, the terminal block 1300 may include fastening parts 1310 and 1320 and multiple connection parts 1331, 1332, and 1333.

The fastening parts 1310 and 1320 may couple the terminal block 1300 on grooves 201 and 202 formed in the rear frame 200. The fastening parts 1310 and 1320 may couple the terminal block 1300 to the rear frame 200 using the screw or other type of fastener. Here, a screw or other type of fastener may be referred to as a “fastener”. Accordingly, the terminal block 1300 may be coupled to the home appliance 1.

The terminal block 1300 may screw couple the internal wires connected to the components within the main body 10 and external wires for supplying power from an external power supply to each other at a plurality of connection parts 1331, 1332, and 1333, to thereby electrically connect the internal wires and the external wires. The terminal block 1300 may connect the internal wires and external wires connected to the components within the main body 10 to each other by the screw at a plurality of connection parts 1331, 1332, and 1333. However, the present disclosure is not necessarily limited thereto, and the internal and external wires may be coupled using various methods, such as a C-clip coupling. Therefore, a screw, a C-clip, or another device to electrically connect the internal and external wires together may be referred to as a “fastener”.

The rear frame 200 may have a hole 3000 formed below the terminal block 1300. The hole 3000 is a space that may penetrate through the inside and outside of the home appliance 1 and provides an extra space for connecting the internal wires to the external wires, etc.

During the screw coupling process between the internal and external wires of the terminal block 1300, the screw may fall through the hole 3000, resulting in the loss of the screw. To prevent this loss, a block guide 1200 may be coupled to the home appliance 1 as illustrated in FIG. 6, to catch the screw.

FIG. 6 is a diagram for describing the block guide 1200 according to at least one embodiment of the present disclosure.

In FIG. 6, the block guide 1200 may be disposed to surround the terminal block 1300.

The block guide 1200 may include a guide part 1210 that can be coupled to the outer side of the terminal block 1300 and a storage part 1220 for storing screws.

The guide part 1210 may be formed in a form in which a central portion is open. The guide part 1210 may include a guide panel 1211, an upper surface portion 1212, and a side surface portion 1213. The terminal block 1300 may be disposed between the guide panel 1211, the upper surface portion 1212, and the side surface portion 1213.

The guide panel 1211 is a member that covers the hole 3000 formed in the main body 10 and guides the screw detached from the terminal block 1300 toward the storage part. The guide panel 1211 may be disposed below the terminal block 1300. The guide panel 1211 may be inserted into the hole 3000 formed in the main body 10. The guide panel 1211 may be formed in the form in which the guide panel 1211 is inclined toward the storage part 1220 as it moves away from the terminal block 1300. Accordingly, the guide panel 1211 may move the screw detached from the terminal block 1300 toward the storage part 1220.

The storage part 1220 may be disposed below the guide part 1210. The storage part 1220 may be disposed in a protruding form from the rear frame 200.

The storage part 1220 may be disposed below the terminal block 1300. The storage part 1220 is configured to store the screw detached from the terminal block 1300. The storage part 1220 may have a gap 4000 formed in the direction of the guide part 1210. Accordingly, the storage part 1220 may allow the screw detached from the terminal block 1300 to move to the storage part 1220 through the gap 4000.

The storage part 1220 may include a front surface portion 1222 and a side surface portion 1224. The front surface portion 1222 may form the first hole 2000. The first hole 2000 is configured to pass the external wire therethrough. Accordingly, the external wire may pass through the first hole 2000 and be connected to the internal wire in the terminal block 1300. In addition, the external wire may pass through the first hole 2000 and supply power to internal devices in the terminal block 1300.

The side surface portion 1224 may be formed in a flat shape on both sides of the storage part 1220. The side surface portion 1224 may include a fourth coupling part 1223 and the protrusion 1221 protruding on one side. The fourth coupling part 1223 may be disposed between the main body 10 and the second coupling part 1127 of the cover 1100 to couple the storage part 1220 to the main body 10. Accordingly, the storage part 1220 may be fixed to the main body 10.

The protrusion 1221 may be formed in a protruding form on the side surface portion 1224 of the storage part 1220. The protrusion 1221 may be coupled to the third coupling part (reference numeral 1125 of FIG. 10) of the cover 1100 to fix the cover 1100 to the block guide 1200.

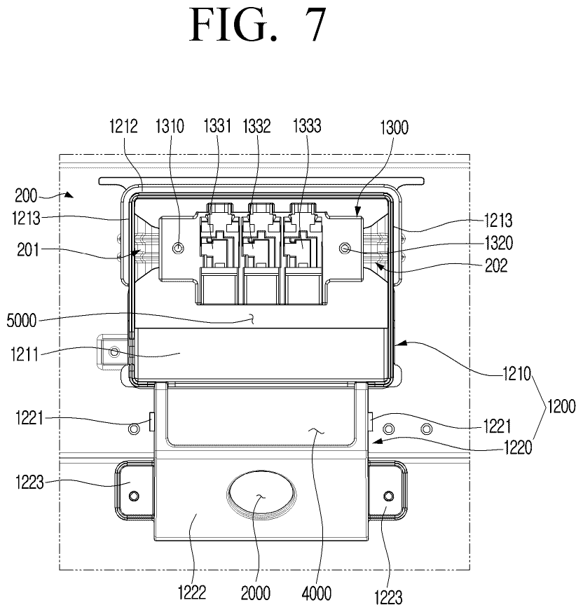

FIG. 7 is a diagram illustrating the terminal block 1300 and the block guide 1200 according to at least one embodiment of the present disclosure.

In FIG. 7, the terminal block 1300 may be disposed on the rear frame 200 of the main body 10. The terminal block 1300 may be coupled through the grooves 201 and 202 that are disposed in a protruding form in the hole 3000 of the rear frame 200. That is, the terminal block 1300 may be fixed by coupling the fastening parts 1310 and 1320 to the grooves 201 and 202. The fastening parts 1310 and 1320 may be coupled to the grooves 201 and 202 in various ways, such as the screw coupling or welding.

In FIG. 7, each of the multiple connection parts 1331, 1332, and 1333 of the terminal block 1300 may be disposed in a single row. Each of the multiple connection parts 1331, 1332, and 1333 may have the internal wires disposed to supply power to different components.

In FIG. 7, the block guide 1200 may include a slot 5000 with one open end. The slot 5000 may be disposed corresponding to the hole 3000 of the main body 10. The guide panel 1211 may be disposed below the slot 5000. Accordingly, the guide panel 1211 may guide the screws detached from the plurality of connection parts 1331, 1332, and 1333 or the fastening parts 1310 and 1320 disposed on the terminal block 1300 toward the storage part 1220.

In FIG. 7, the storage part 1220 may include the protrusion 1221, the fourth coupling part 1223, the front surface portion 1222, the gap 4000, and the first hole 2000.

The protrusion 1221 may protrude toward the side surface portion 1224 of the storage part 1220. The fourth coupling part 1223 may protrude toward the side surface portion 1224 of the storage part 1220. The protrusion 1221 and the fourth coupling part 1223 may be coupled to the cover 1100 in different ways.

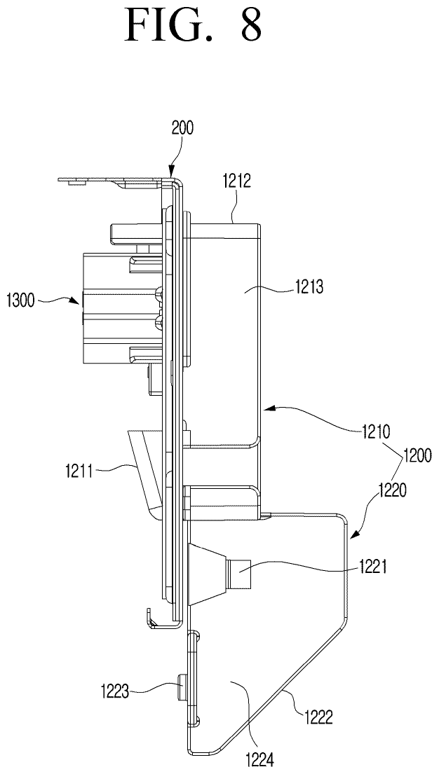

FIG. 8 is a diagram for describing a power supply device 1000 according to at least one embodiment of the present disclosure.

In FIG. 8, the terminal block 1300 may be disposed in the form in which the terminal block 1300 is inserted into the rear frame 200 of the main body 10. The terminal block 1300 may be connected to internal wires of various internal components within the main body 10. The terminal block 1300 may be connected to external wires at a location where the terminal block 1300 contacts a side surface portion of the rear frame 200.

The guide panel 1211 of the block guide 1200 may be disposed in the form in which the guide panel 1200 is inserted into the rear frame 200 of the main body 10.

The guide panel 1211 may be formed to be inclined to one side. The guide panel 1211 may be formed to be inclined toward the storage part 1220 as it goes downward.

The block guide 1200 and the cover 1100 may be disposed on opposite sides of the terminal block 1300 with respect to the rear frame 200.

In this specification, the block guide 1200 and the cover 1100 are described, but are not necessarily limited thereto. The block guide 1200 and the cover 1100 may each be referred to by various terms, such as a first housing and a second housing, a first cabinet and a second cabinet, a first shell and a second shell, a first frame and a second frame, a first body and a second body, and a first enclosure and a second enclosure.

The cover 1100 may be disposed to surround the outer side of the block guide 1200.

The cover 1100 may include a first cover part 1110 and a second cover part 1120. The first cover part 1110 is configured to protect the terminal block 1300. The first cover part 1110 may include an upper surface portion 1111, a front surface portion 1112, and a side surface portion 1113.

The upper surface portion 1111, the front surface portion 1112, and the side surface portion 1113 of the first cover part 1110 may include an elastic body 1111b, 1112b, and 1113b on the inner side surface to protect the terminal block. Accordingly, the first cover part 1110 may absorb external impacts and protect the terminal block 1300.

The upper surface portion 1111, the front surface portion 1112, and the side surface portion 1113 of the first cover part 1110 may include an absorbent member 1111a, 1112a, and 1113a to absorb moisture penetrating from the outside. Accordingly, the first cover part 1110 may protect the terminal block 1300 from moisture penetrating from the outside.

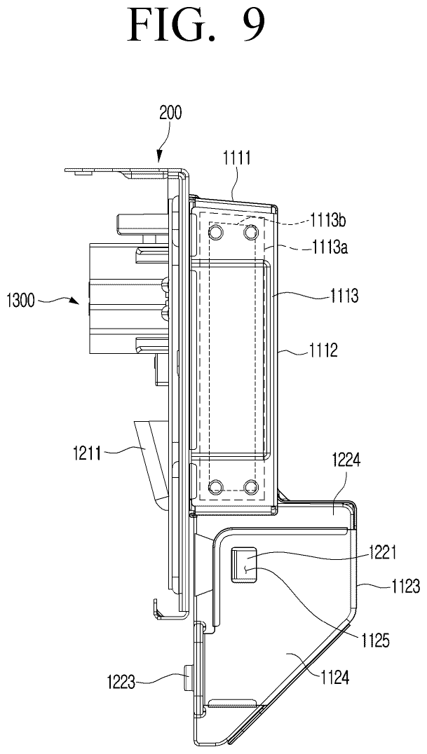

FIG. 9 is a diagram for describing the block guide 1200 according to at least one embodiment of the present disclosure.

In FIG. 9, the block guide 1200 may include the guide part 1210 and the storage part 1220.

The guide part 1210 may include the upper surface portion 1212, the side surface portion 1213, and the guide panel 1211.

The upper surface portion 1212 of the guide part 1210 may include a member disposed on the inner side of the rear frame 200 and a member disposed on the outer side.

The side surface portion 1213 of the guide part 1210 may include a fastening protrusion 1217 for coupling with the cover 1100. The fastening protrusion 1217 may meet and be fixed to the inner side surface of the side surface portion 1113 of the first cover part 1110.

The guide part 1210 may include a slot 5000 between the upper surface portion 1212, the side surface portion 1213, and the guide panel 1211. The guide part 1210 may guide the screw detached from the terminal block 1300 through the slot 5000 toward the storage part 1220.

The storage part 1220 may include a side surface portion 1224, a first space 6000, and a storage panel 1225.

The side surface portion 1224 of the storage part 1220 may be formed in a flat shape. The side surface portion 1224 of the storage part 1220 may include the protrusion 1221 and the fourth coupling part 1223 on the outer surface. Detailed descriptions of the protrusion 1221 and the fourth coupling part 1223 have been described above, and therefore, a description thereof will be omitted.

The first space 6000 of the storage part 1220 is an open space. The first space 6000 may be disposed between the rear frame 200 of the main body 10 and the storage part 1220. The space between the rear frame 200 and the storage part 1220 may be narrower than the size of the screw. Accordingly, the screw detached from the terminal block 1300 may not be detached from the storage part 1220.

The storage panel 1225 may be disposed below the first space 6000 of the storage part 1220. The storage panel 1225 may be formed in the form in which the storage panel 1225 partially protrudes upward from the lower side of the storage part 1220. Accordingly, the storage panel 1225 may prevent the screw detached from the terminal block 1300 from being detached from the storage part 1220.

The screw removed from the terminal block 1300 may be seated in the space between the storage panel 1225 and the front surface portion 1222 of the storage part 1220.

However, this is not necessarily limited thereto, and the first space 6000 and the storage panel 1225 may be formed integrally. For example, the storage part 1220 may fill the entire first space 6000 with the storage panel 1225. Conversely, the storage part 1220 may fill the entire first space 6000 without the storage panel 1225.

FIG. 10 is a diagram illustrating the cover 1100 according to at least one embodiment of the present disclosure.

In FIG. 10, the cover 1100 may include the first cover part 1110 and the second cover part 1120.

The first cover part 1110 may include the upper surface portion 1111, the front surface portion 1112, and the side surface portion 1113.

The upper surface portion 1111 may include the first coupling part 1117. The first coupling part 1117 may be coupled to a protruding portion at the center of the upper surface portion 1212 of the block guide 1200. Accordingly, the first cover part 1110 may be fixed to the block guide 1200.

The front surface portion 1112 of the first cover part 1110 may include the absorbent member 1111a, 1112a, and 1113a disposed on the inner side surface thereof to face the terminal block 1300 to absorb moisture penetrating from the outside.

The front surface portion 1112 of the first cover part 1110 may include the elastic body 1111b, 1112b, and 1113b disposed on the inner side surface thereof to face the terminal block 1300 to absorb the external impact. Accordingly, the durability of the washing machine 100 may be increased.

Here, the elastic body 1111b, 1112b, and 1113b may include various materials, such as rubber and silicone.

The side surface portion 1113 of the first cover part 1110 may cover the outer side surface of the side surface portion 1213 of the block guide 1200.

The second cover part 1120 may be disposed below the first cover part 1110. The second cover part 1120 may include the first front surface portion 1122, the second front surface portion 1123, and the side surface portion 1124.

The second front surface portion 1123 may be disposed below the first cover part 1120. The second front surface portion 1123 may be formed in a flat shape and may be disposed parallel to the front surface portion 1112 of the first cover part 1110.

The first front surface portion 1122 may be disposed below the second front surface portion 1123. The first front surface portion 1122 may be formed in the form in which the first front surface portion 1122 is inclined at a certain angle from the lower side of the second front surface portion 1123. The first front surface portion 1122 may be inclined in a direction that the first front surface portion 1122 approaches the rear frame 200 as it goes toward the lower side of the second front surface portion 1123.

The first front surface portion 1122 may form the second hole 2000. The second hole 2000 may be formed at a location corresponding to the first hole disposed in the storage part 1220 of the block guide 1200. The first hole of the block guide 1200 and the second hole of the cover 1100 allow external wires to pass therethrough. Accordingly, the external wires may be connected to the terminal block 1300 through the first hole of the block guide 1200 and the second hole of the cover 1100. Accordingly, power may be supplied to the components within the home appliance 1.

The second coupling part 1127 may be formed in the form in which the second coupling part 1127 protrudes outward from the side surface portion 1124 of the second cover part 1120.

The second coupling part 1127 may be coupled to the block guide 1200 and the rear frame 200. As the coupling method, various coupling methods, such as screw coupling and thread coupling, may be employed.

The third coupling part 1125 may be formed on the side surface portion 1124 of the second cover part 1120 in the form that the third coupling part 1125 penetrates through the side surface portion 1124.

The third coupling part 1125 may be formed at a position corresponding to the protrusion 1221 formed on the storage part 1220 of the block guide 1200. The third coupling part 1125 may be fastened to the protrusion 1221 formed on the storage part 1220 of the block guide 1200. Accordingly, the second cover part 1120 may be coupled to the block guide 1200.

The power supply device 1000 is formed in the form in which the cover 1100, the block guide 1200, and the terminal block 1300 are coupled, and the coupling of these components may prevent the screw detached from the terminal block 1300 coupled to the home appliance 1 from losing.

Each of the components described in this document may be composed of one or more components, and the names of the corresponding components may vary depending on the type of home appliance

Although various embodiments of the present disclosure have been individually described hereinabove, the respective embodiments are not necessarily implemented alone, and may also be implemented so that configurations and operations thereof are combined with those of one or more other embodiments.

Although exemplary embodiments of the present disclosure have been illustrated and described hereinabove, the present disclosure is not limited to the abovementioned specific exemplary embodiments, but may be variously modified by those skilled in the art to which the present disclosure pertains without departing from the gist of the present disclosure as disclosed in the accompanying claims. These modifications should also be understood to fall within the scope and spirit of the present disclosure.

What is claimed is:

1. A washing machine, comprising:
a main body; and
a power supply device on a side of the main body, the power supply device including:
a terminal block configured to electrically connect an external wire and an internal wire that are couplable together by a first fastener, wherein the internal wire is electrically connected to a component within the main body such that, when the external wire and the internal wire are electrically connected by the terminal block and coupled together by the first fastener, power from an external power supply is suppliable through the external wire and the internal wire to the component,
a block guide surrounding the terminal block and configured to, in an event that the first fastener falls, catch and store the first fastener, and
a cover covering the terminal block and the block guide.

2. The washing machine as claimed in claim 1, wherein the block guide includes a storage part below the terminal block and configured to, in the event that the first fastener falls, store the first fastener.

3. The washing machine as claimed in claim 2, wherein the block guide includes a guide panel that covers a hole formed in the main body and, in the event that the first fastener falls, guides the first fastener toward the storage part to be stored in the storage part.

4. The washing machine as claimed in claim 1, wherein the cover includes an absorbent member on an inner side surface of the cover and facing the terminal block to absorb moisture penetrating from outside of the cover.

5. The washing machine as claimed in claim 2, wherein
the storage part includes a first hole,
the cover includes a second hole, and
the second hole and the first hole are configured such that the external wire is passable through the second hole and the first hole to be electrically connected to the internal wire by the terminal block.

6. The washing machine as claimed in claim 1, wherein the cover includes an elastic body on an inner side surface of the cover and facing the terminal block, to absorb external impact.

7. The washing machine as claimed in claim 5, wherein a surface of the storage part in which the first hole is disposed, is inclined toward the main body as the surface of the storage part is further downward.

8. The washing machine as claimed in claim 2, wherein the storage part includes a storage panel configured to, in the event that the first fastener falls, seat the first fastener in the storage part.

9. The washing machine as claimed in claim 1, wherein
the terminal block is coupled to the main body by a second fastener, and
the block guide is configured to, in the event that the second fastener falls, catch and store the second fastener.

10. A power supply device, comprising:
a terminal block couplable to a main body of a home appliance and configured to, while coupled to the main body, electrically connect an external wire and an internal wire that are couplable together by a first fastener, wherein the internal wire is electrically connectable to a component within the main body such that, when the external wire and the internal wire are electrically connected by the terminal block and coupled together by the first fastener with the internal wire connected to the component, power from an external power supply is suppliable through the external wire and the internal wire to the component;
a block guide configured to surround the terminal block coupled to the main body and, while surrounding the terminal block, to, in an event that the first fastener falls, catch and store the first fastener; and
a cover configured to cover the terminal block coupled to the main body and the block guide surrounding the terminal block.

11. The power supply device as claimed in claim 10, wherein the block guide includes a storage part that, while the terminal block is coupled to the main body and the block guide surrounds the terminal block, is below the terminal block and, in the event that the first fastener falls, stores the first fastener.

12. The power supply device as claimed in claim 11, wherein the block guide further includes a guide panel that, while the terminal block is coupled to the main body and the block guide surrounds the terminal block, and in the event that the first fastener falls, guides the first fastener toward the storage part to be stored in the storage part.

13. The power supply device as claimed in claim 10, wherein the cover further includes an absorbent member on an inner side surface of the cover and that, while the terminal block is coupled to the main body, the block guide surrounds the terminal block, and the cover covers the terminal block and the block guide, faces the terminal block to absorb moisture penetrating from outside of the cover.

14. The power supply device as claimed in claim 10, wherein the cover includes an elastic body on an inner side surface of the cover that, while the terminal block is coupled to the main body, the block guide surrounds the terminal block, and the cover covers the terminal block and the block guide, faces the terminal block to absorb external impact.

15. The power supply device as claimed in claim 10, wherein
the terminal block is couplable to the main body by a second fastener, and
the block guide is configured to, while the terminal block is coupled to the main body, the block guide surrounds the terminal block, and the cover covers the terminal block and the block guide, and in the event that the second fastener falls, catch and store the second fastener.

16. A washing machine, comprising:
a main body; and
a power supply device on a side of the main body, the power supply device including:
a terminal block coupled to the main body by a fastener, and configured to electrically connect an external wire and an internal wire, wherein the internal wire is electrically connected to a component within the main body such that, when the external wire and the internal wire are electrically connected by the terminal block, power from an external power supply is suppliable through the external wire and the internal wire to the component,
a block guide surrounding the terminal block and configured to, in an event that the fastener falls, catch and store the fastener, and
a cover covering the terminal block and the block guide.

17. The washing machine as claimed in claim 16, wherein the block guide includes a storage part below the terminal block and configured to, in the event that the fastener falls, store the fastener.

18. The washing machine as claimed in claim 17, wherein the block guide includes a guide panel that covers a hole formed in the main body and, in the event that the fastener falls, guides the fastener toward the storage part to be stored in the storage part.

19. The washing machine as claimed in claim 17, wherein
the storage part includes a first hole,
the cover includes a second hole, and
the second hole and the first hole are configured such that the external wire is passable through the second hole and the first hole to be electrically connected to the internal wire by the terminal block.
